(19) United States
(12) Patent Application Publication
(10) Pub. No.: US 2026/0028436 A1
(43) Pub. Date: Jan. 29, 2026

(54) METHOD FOR PRODUCING POLYVINYLIDENE FLUORIDE IN A MEMBRANE REACTOR

(71) Applicant: RHEINISCH-WESTFÄLISCHE TECHNISCHE HOCHSCHULE (RWTH) AACHEN, Aachen (DE)

(72) Inventors: Stefan Herrmann, Aachen (DE); Matthias Wessling, Aachen (DE)

(73) Assignee: RHEINISCH-WESTFÄLISCHE TECHNISCHE HOCHSCHULE (RWTH) AACHEN, Aachen (DE)

(21) Appl. No.: 18/994,509

(22) PCT Filed: Jul. 27, 2023
(86) PCT No.: PCT/EP2023/070876

§ 371 Date: Jan. 14, 2025

(30) Foreign Application Priority Data
Jul. 28, 2022 (DE) 10 2022 118 981.3

(51) Int. Cl. C08F 14/22; C08F 2/01

(52) U.S. Cl. CPC C08F 14/22; C08F 2/01

(57) ABSTRACT

The present invention relates to a process for producing polyvinylidene fluoride by polymerization of vinylidene fluoride, in particular using a polymerization reactor comprising a membrane.

The present invention relates to a process for producing polyvinylidene fluoride.

The present invention relates in particular to a process which in particularly advantageous fashion makes it possible to achieve an interface between a gaseous monomer phase and an aqueous reaction phase in the context of a polymerization of vinylidene fluoride.

The conventional polymerization of vinylidene fluoride (VDF) to afford polyvinylidene fluoride (PVDF) is carried out in discontinuously operated stirred-tank reactors. The VDF is present in the reactor in gaseous form as monomer and must be dissolved in an aqueous phase for the polymerization. This requires a phase interface between the monomer and the aqueous phase which in stirred-tank reactors is provided by bubble formation using a stirrer. The required phase interface between the gaseous monomer and the aqueous reaction phase is more precisely generated by bubble formation and breakup. A high mechanical energy input of low efficiency in terms of formation of the phase interface is thus necessary.

Since the solubility of the monomer in water is very low, the polymerization is severely mass transfer-limited and, aside from the process pressure, the phase interface is the decisive process parameter for reducing this limitation. To increase the monomer solubility in the aqueous phase, the polymerization is usually carried out at high pressures of 10-300 bar or even considerably higher.

In addition to the additional energy input for the compression of the gas, prior art solutions may also be affected by safety problems, in particular due to large amounts of flammable gas at high pressure and a high temperature within the reactor. Furthermore, conventional production of PVDF employs fluoroemulsifiers which exhibit environmental persistence and are hazardous to health. While earlier emulsifiers such as perfluorooctanoic acid (PFOA) have been prohibited in the EU since 2020, use is made of substitutes which differ only minimally from perfluorooctanoic acid in terms of their chemical structure and are likewise potentially persistent and bioaccumulative fluorine emulsifiers.

US 2002/123585 A1 describes a continuous process for producing PVDF homopolymer or copolymer. The optional comonomer consists of a free-radically polymerized vinyl group and comprises at least one fluorine atom, a fluoroalkyl group or a fluoroalkoxy group, bonded directly to this vinyl group. This document also relates to PVDF homopolymers produced by the processes described herein. In terms of a polymerization of PVDF, this document describes in particular that a high-pressure process of more than 300 bar is used.

DE 10 2020 102 420 A1 describes a gas-liquid reactor for bubble-free gasification of a process liquid with a process gas, wherein the reactor has at least one outer reactor shell, a stirring unit and a gasification unit having a feed conduit for the process gas into the reactor, wherein the feed conduit for the process gas terminates in a first gas-receiving space within the reactor which is gastightly connected to a plurality of membranes selected from the group consisting of diffusion or microfiltration membranes, or combinations of at least two membrane types thereof, and the process gas is passed via the membranes into a second gas-receiving space inside the reactor which is gastightly connected to the other ends of the membranes. Both gas-receiving spaces are arranged concentrically with the stirrer axis of the stirring unit and are mechanically connectable to one another, wherein the gas-receiving spaces and the membranes arranged therebetween substantially form a cylinder shell within the reactor and the arrangement of the membranes relative to the stirrer axis is selected from the group consisting of orthogonal-concentric or axial-concentric. Such a reactor is used for supplying bacteria in a nutrient medium with oxygen.

However, the solutions known from the prior art may still have potential for improvement, in particular with regard to efficient polymerization of vinylidene fluoride, for production of polyvinylidene fluoride and/or copolymers thereof.

An object addressed by the present invention is accordingly that of developing a measure which at least partially overcomes at least one disadvantage from the prior art. In particular, an object addressed by the present invention is that of providing a solution which allows efficient production of polyvinylidene fluoride.

According to the invention, the problem is solved by a process having the features of claim 1. Preferred embodiments of the invention are disclosed in the dependent claims, in the description and in the figures, wherein further features described or disclosed in the dependent claims or in the description or the figures may represent subject matter of the invention individually or in any desired combination, unless the contrary is clearly apparent from the context.

The present invention relates to a process for producing polyvinylidene fluoride or a polyvinylidene fluoride copolymer by polymerization of at least vinylidene fluoride as monomer, wherein the process comprises at least the process steps of:
i) providing a continuously operable polymerization reactor, wherein the polymerization reactor comprises a monomer space and a polymerization space separated from the monomer space by a preferably hydrophobic membrane:
ii) introducing vinylidene fluoride into the monomer space at a first pressure p₁;
iii) introducing an aqueous polymerization solution into the reaction space at a second pressure p₂, wherein
iv) p₁ is greater than or equal to p₂; wherein
v) the vinylidene fluoride passes into the aqueous phase and vi) a polymerization of vinylidene fluoride to afford polyvinylidene fluoride or a polyvinylidene fluoride copolymer occurs in the reaction space.

Such a process allows advantageous polymerization of vinylidene fluoride and optionally a further monomer to produce polyvinylidene fluoride or optionally a polyvinylidene fluoride copolymer.

The described process comprises at least the following process steps, wherein the process steps described below may proceed in the specified sequence but may also be provided at least partly simultaneously or in a different sequence.

Process step i) comprises initially providing a continuously operable polymerization reactor, wherein the polymerization reactor comprises a monomer space and a polymerization space separated from the monomer space by a membrane.

In particular, the polymerization reactor in the described process is operated continuously, which may understandably entail efficiency advantages for those skilled in the art. In particular when run in continuous mode, the process described here further offers advantages over stirred-tank reactors according to the prior art, since setup and purification times between batches greatly reduce the space-time yield of stirred tanks.

Furthermore, a polymerization reactor may in principle be any object which satisfies the described definition and in which the process is performable.

To this end, the polymerization reactor comprises a monomer space and a polymerization space. Both spaces are configured and preferably connected to appropriate peripheral apparatus, such as in particular discharge conduits and feed conduits, such that one or more monomers may be introduced into the monomer space and that correspondingly an aqueous reaction solution may be introduced in the polymerization space and the polymerization conducted. To this end, the monomer space and the polymerization space, which may also be referred to as reaction space, may preferably be correspondingly pressure-resistant. Appropriate temperature-control means may also be provided, preferably to effect heating or optionally also to effect cooling of the reactor or of the medium in the reactor.

The monomer space and the polymerization space are further separated by a membrane.

The membrane is preferably hydrophobic. In the context of the present invention, “hydrophobic membrane” is to be understood as meaning that the membrane exhibits hydrophobic properties with respect to water. This in turn means for example that the contact angle, also referred to as wetting angle, of ultrapure water (conductivity≤1.1 μS/cm at 20° C., total organic carbon≤0.5 mg/l, nitrate≤0.2 mg/l) is more than 75°. In the case of a corresponding contact angle below 75°, reference may be made according to the invention to a hydrophilic membrane or to hydrophilic properties of the membrane.

There are in principle different options for rendering the membrane hydrophobic, as is described below in greater detail. For example, the membrane itself may be formed from a hydrophobic material or else from a non-hydrophobic or slightly hydrophobic material and provided with a coating which exhibits or improves corresponding hydrophobic properties.

However, it is also possible according to the invention for the membrane to have hydrophilic properties. Advantageous to this end are, for example, hydrophilic membranes or else hydrophobic membranes provided with a hydrophilic coating, such as for instance polyethylene glycol (PEG), polyvinyl alcohol (PVA), poly(ethylene glycol) diacrylate (PEGDA), poloxamers, meroxapols and/or crosslinked mixtures comprising at least one of the aforementioned constituents. It is also possible for a filter cake to result in hydrophilic properties. The in particular very thin hydrophilic layer impairs gas transport only immaterially but brings great advantages in terms of prevention of deposits (PVDF particles, emulsifiers) or of fouling on the membrane which would reduce mass transfer.

The membrane is also porous for example i.e. provided with pores which connect the monomer space to the polymerization space. The pores can be chosen freely in terms of shape, distribution, number and size to the extent that passage of the monomer gas from the monomer space into the polymerization space is possible in particular in such a way that passage of the aqueous reaction solution into the monomer space can be prevented.

The pores may in this case be configured in terms of shape and size in such a way that under the reaction conditions bubble-free entry of the monomer gas into the liquid in the reaction space may be made possible. To this end, the pores may be adapted to the material of the membrane and in particular to the properties of the membrane. It is therefore possible to avoid the need to break up the bubbles, which requires a high energy input. Gas bubble-free introduction may in particular be made possible via hydrophobic properties of the membrane with suitable pressure properties in the monomer space and in the polymerization space. It may accordingly be preferable when process steps ii) and iii) are carried out in such a way that gas bubble-free introduction of monomer gas, in particular of vinylidene fluoride, into the aqueous solution is effected.

The membrane may also be non-porous. In this case it is possible to provide for example an embodiment with a PDMS (polydimethylsiloxane) coating which is media-tight or pore-free. In terms of mass transfer, passage of the monomer or the monomers in the sense of the solution-diffusion model as described for instance in Membrane Technology and Applications, Richard W. Baker, Wiley, 2004 may be assumed.

In order to enable polymerization, it is further provided that according to process step ii) vinylidene fluoride is introduced into the monomer space at a first pressure pi and that according to process step iii) an aqueous polymerization solution, which may also be referred to as reaction solution, is introduced into the reaction space at a second pressure p₂. More precisely, it is provided here that p₁ is greater than or equal to or less than p₂.

With regard to the polymerization solution, it may be preferable for it and thus the aqueous process streams that enter the reactor to be freed of oxygen before entry into the reactor. To this end, for example the reservoir containers are flooded with nitrogen and a degasifier, for instance a membrane degasifier, capable of removing dissolved gases from the liquids is arranged upstream of the pump used for conveying the aqueous process streams. The monomer stream may in principle also be depleted in certain gases, for instance oxygen, and preferably freed of oxygen.

The corresponding pressure ranges may be selected according to the specific requirements both in terms of their magnitude and in terms of the ratio of p₁ and p₂.

For example, operation with p₂>p₁ may be provided. This further suppresses bubble formation but mass transfer remains possible since it is concentration-driven and the two phases remain in contact at the pore/membrane surface.

Operation where p₂<p₁ results in particularly efficient introduction of gas into the water phase, thus making it possible to ensure a high conversion since the gas introduction is relatively high.

Operation at p₂=p₁ can allow relatively low bubble introduction at relatively high conversion.

The corresponding polymerization conditions are accordingly provided in the polymerization reactor and more precisely in the monomer space and in the polymerization space. More precisely, the monomer space is supplied with monomer which can pass through the membrane into the polymerization space. This is effected according to process step v), according to which the vinylidene fluoride and any comonomers provided pass into the aqueous phase.

A polymerization of vinylidene fluoride may then accordingly occur in the aqueous phase in the polymerization space according to process step vi), thus forming polyvinylidene fluoride. As indicated above, it is also possible to introduce a further monomer into the monomer space or into the polymerization space in addition to vinylidene fluoride, in order to produce a polyvinylidene fluoride copolymer.

The polymer formed, such as in particular the polyvinylidene fluoride, may then be discharged from the reactor after the reaction, in particular in the case of continuous operation of the reactor, and then separated from the aqueous phase and optionally washed and dried.

Such a process has distinct advantages over solutions from the prior art.

The use of an above-described process and in particular the use of the described continuous membrane reactor makes it possible to provide a gas-liquid phase interface with only very few gas bubbles, if any. To this end, the membrane is used as a contactor between the two phases, i.e. the gaseous monomer phase and the liquid polymerization phase. The membrane reliably separates the phases from one another.

The invention provides the necessary phase interface in a continuous, for example tubular, reactor by means of a membrane and it has been shown that the polymerization may be performed in this reactor without the use of fluoroemulsifiers or, in other words, that the process or the polymerization phase is free from fluoroemulsifiers. On the contrary, the described process makes it possible to eschew emulsifiers or to use emulsifiers selected from meroxapols and poloxamers, which may be used without issue or at least exhibit a significantly reduced risk potential.

This can therefore be highly advantageous, since the fluoroemulsifiers hitherto employed on an industrial scale are a problem of conventional production processes, since they are are highly polluting to the environment, and even substitutes for PFOA are soon likely to be difficult to obtain and usable only disadvantageously. The disadvantage from the prior art, for instance when using stirred-tank reactors, that large amounts of aqueous solution with environmentally harmful substances, for instance PFOA or similar alternatives, are generated and require disposal can therefore be avoided.

In addition to an emulsifier, the provision of an initiator may be important for the polymerization reaction and may be introduced for instance with the aqueous reaction solution.

Mechanical energy input, for instance using active stirrers, such as are known from the prior art in particular when using stirred-tank reactors, may also be avoided according to the invention. This reduces the energy consumption of the reaction and further allows a simple and cost-effective design of the polymerization reactor. This is a significant advantage over solutions from the prior art since the generation of the phase interface for gas introduction with a stirrer requires a high mechanical energy input into the reactor, only a fraction of which is used to generate a phase interface between monomer gas and aqueous phase, thus allowing only a low efficiency.

It is also possible to eschew the use of high process pressures, which are usually necessary according to the prior art but likewise entail a disadvantage of prior-art production processes both from an energetic standpoint and for process safety. For example, large amounts of flammable gas are generated at high pressures in the reactor in the prior art.

According to the invention, it is further possible to realize a continuous process in a flow tube reactor where cleaning and setup times as in batch operation are obviated. This is particularly advantageous since batch operation in PVDF production to date in particular has the disadvantage of long polymerization times followed by cleaning and setup times, before the next batch may be produced in the reactor. As a result of strongly increasing world market demand for PVDF, in particular due to the use of the material in battery production, economic and efficient processes for production will in future be of ever greater importance, as a result of which the process according to the invention can allow particular advantages in this regard too.

The use of such a polymerization reactor for the polymerization of vinylidene fluoride advantageously allows control of the local reaction conditions, such as in particular pressure, temperature and concentration (p, T, C). This allows elimination of corresponding deficiencies of batch reactors and a comprehensive design and process and product quality control, which cannot be achieved with current batch reactors, are made possible.

It is likewise advantageous in accordance with the invention, in particular with regard to the use of stirred tanks from the prior art, that the residence times of the reactants may be very homogeneous as a result of very good commixing, as can the concentration distribution in the reaction phase. This in turn can make it possible very defined and reliable reaction conditions.

It is also possible to overcome the disadvantages of stirred reactors which suffer from poor heat input/output due to a poor volume to surface area ratio and resulting temperature gradients in the stirred tank, thus in turn leading to inhomogeneous reaction conditions.

The process according to the invention therefore results in a very homogeneous product quality and variations in product quality between individual batches can be avoided since, despite polymerization reactions being very sensitive to variations in process parameters, this is unproblematic according to the invention as described above as a result of homogeneous and defined process parameters. By contrast, non-attainment of a so-called steady state in the reactor in the case of prior-art stirred tanks results in constantly changing process parameters, whose change differs slightly from batch to batch, thus having an adverse effect on product quality.

Finally, upscaling leads to intensification of the aforementioned problems in the case of stirred tanks, but is readily possible according to the invention.

It is preferable when the membrane comprises at least one of a ceramic and a polymer. It has been found that in particular these materials may be used to form membranes which in terms of pores and hydrophobic character are or may be made particularly advantageous for the process described here and can in particular withstand the reaction conditions or exhibit long-term stability thereto. The membrane may comprise only a ceramic, only a polymer or else a ceramic and a polymer.

When using a polymer, such as for instance a polyolefin or polyolefin copolymer, particularly preferably when using polypropylene, it may be advantageous in this regard when the aforementioned properties are already accompanied by inherently hydrophobic properties.

Production thereof may therefore be particularly advantageous. The membrane may also be made of polydimethylsiloxane (PDMS) or polytetrafluoroethylene (PTFE), for example in media-tight or pore-free form or else porous form.

Using a ceramic material, such as preferably aluminium oxide (Al₂O₃), to produce the membrane makes it possible to achieve particularly advantageous stability characteristics. A membrane may thus in particular comprise a carrier layer, also known as a support, made of aluminium oxide. Aluminium oxide may also serve as an active layer which controls or influences gas passage. The ceramic membrane may also comprise an active layer of titanium dioxide (TiO₂) or zirconium dioxide (ZrO₂), which may be arranged for example on an aluminium oxide layer.

As described above, the membrane may also comprise a ceramic and a plastic. To achieve the hydrophobic properties, it is possible to provide the ceramic for example with a hydrophobic coating. Materials suitable for such a coating likewise include for instance a polymer, for example polytetrafluoroethylene (PTFE) or else polydimethylsiloxane (PDMS), which again may be applied to a ceramic support, for example to a support composed of aluminium oxide. The coating may in particular be on the reaction side, i.e. on the side of the aqueous medium, and may further serve as an active layer.

The polymers may thus be applied as a coating or, for instance acting as a filter cake, introduced between the support layer and the active layer of the membrane. Polymer particles, such as for instance PTFE particles or PDMS particles, may then be present in the membrane structure in proximity to the surface.

It may thus be preferable in principle when the membrane is made of a material selected from the group consisting of aluminium oxide, titanium dioxide, zirconium dioxide, polytetrafluoroethylene, polydimethylsiloxane and polypropylene.

Alternatively, the membrane may also exhibit hydrophilic properties and comprise for instance polyethylene glycol (PEG), polyvinyl alcohol (PVA), poly(ethylene glycol) diacrylate (PEGDA), poloxamers, meroxapols and/or crosslinked mixtures comprising at least one of the aforementioned constituents.

It may further be preferable when a pressure difference between p₁ and p₂ is in a range of ≤2 bar. This embodiment particularly preferably allows gas bubble-free introduction of the monomer into the aqueous polymerization phase. It is further possible in particular in this embodiment to operate at low pressure, thus making it possible to reduce demands on the apparatus setup and simplify the process as a whole. In particular, the low transmembrane pressure may be particularly advantageous for membrane selection since the membrane does not experience any significant mechanical forces due to pressure difference. The process pressure, i.e. p₁ and p₂, may therefore be relatively high, without the membrane being subjected to high mechanical stresses.

With regard to the specified reaction pressures, preference may in particular be given to an embodiment in which the pressure in the polymerization reactor, i.e. both of the monomer phase, i.e. in the monomer space, and of the reaction phase, i.e. in the polymerization space, is in a range of ≤50 bar, for example ≤30 bar, particularly preferably ≤10 bar. This makes it possible to reduce the apparatus requirements, which can improve complexity and costs.

In terms of the configuration of the reactor, it may further be advantageous when the polymerization reactor comprises a plurality of in particular serially connected tubular membranes arranged in a common reactor housing. This embodiment makes it possible in simple fashion to ensure a very long travel path of the components along the reactor through serial connection of the respective membranes. This makes it possible to achieve a long contact time of the monomer phase and the reaction phase with a relatively compact reactor, thus ensuring a high conversion and increasing the efficiency of the process. This also makes it possible to achieve a high molecular weight of the polymer produced.

In this embodiment, the aqueous reaction medium may for example be conducted inside the preferably cylindrical membranes and the monomer gas may be conducted in the reactor outside the membranes. However, it is in principle also possible to employ an opposite reaction mode where the monomer gas is conducted inside the membranes and the reaction medium is conducted in the reactor outside the membranes. However, the former variant may be particularly advantageous with regard to the molecular weight produced.

It may further be preferable when the membrane comprises a plurality of in particular serially connected flow channels. In this embodiment, a multiplicity of channels may thus be present in the interior of a membrane, thus in turn making it possible to ensure a very long travel path of the components along the reactor through serial connection of the respective membranes. This makes it possible to achieve a long contact time of the monomer phase and the reaction phase with a relatively compact reactor, thus ensuring a high conversion and/or making it possible to achieve a high molecular weight. The aqueous phase is preferably supplied to the lumen of the membrane while the gas phase is on the shell side, wherein a reactor housing may enclose the membrane. In other words, the membrane can have monomer gas flow around it from outside. This configuration makes it possible to achieve particularly high pressures, thus improving monomer solubility in the aqueous reaction medium.

However, a parallel connection of a plurality of membranes or of a plurality of flow channels may in principle also be advantageous. This allows a larger amount of reaction medium to flow through the reactor simultaneously, which can likewise allow advantages in terms of throughput, i.e. the reaction quantity.

In principle, it may be further preferred when the reactor has a cylindrically wound configuration, i.e. the total arrangement of membranes and reactor housing comprises a corresponding winding.

This makes it possible to further minimize the size of the reactor and to further generate a secondary flow in the form of Taylor vortices, to allow better commixing of the aqueous phase. This makes it possible to further improve the polymerization conditions. In particular in this embodiment, a parallel connection of a plurality of membranes or polymerization spaces may be advantageous since the winding can ensure a long residence time even when space is limited and a serial connection is thus often unnecessary.

With regard to a serial connection of the respective channels as described above, it may be provided that the membranes of the polymerization reactors are sealed at the respective axial ends by cap structures which comprise deflection structures connecting the respective channels. This allows connection of the channels which is simple in terms of apparatus while at the same time allowing simple servicing and safe sealing of the membrane of the reactor.

It may further be preferable when the polymerization space has a static mixer structure arranged in it. Such a mixer structure may in particular also be understood as meaning a structure which can also introduce radial flow components into the liquid reaction medium. This allows the concentration in the reaction phase to be much more homogeneous, which in turn allows more monomer to be absorbed in the reaction phase, without altering the maximum monomer concentration. This makes it possible to improve the polymerization conversion and/or the efficiency of the polymerization process. It is also possible to prevent deposits of the incipient solid particles of the polymer formed on the membrane and thus prevent blockage of the polymerization reactor. Deposits on the membrane surface which would not necessarily lead to a blockage but would impede or retard monomer transport from the monomer space into the reaction space and thus adversely affect the reaction can also be reduced.

It is further preferable when at least one of the membrane and the mixer structure is provided with a catalyst. For example, the catalyst may be immobilized on the surface of the membrane or of the mixer structure or else be comprised in an additional coating. Examples of catalysts that may be mentioned, without being limited in principle thereto, include for instance Ziegler-Natta catalysts. Provision of a catalyst on the membrane or the mixer structure can have a further positive influence on the polymerization, which may for instance have a positive effect on molecular weight distribution.

It may further be preferable when the process is performed in at least two serially connected polymerization reactors. This embodiment makes it possible to achieve substantially the advantages described above for serially connected membranes. In particular, the residence time of the polymerization solution in a polymerization reactor and thus the polymerization time may be extended, which may have an advantageous effect on the molecular weight of the polymer produced. This is also possible when the individual membranes may provide a relatively short residence time. This also allows simple alteration of the temperature management over the progress of the reaction. For example, the first reactor may be heated to a greater extent than the subsequent reactor by for instance arranging different heating tapes around the reactors.

It may further be preferable when, in a polymerization reactor, a material stream is introducible or dischargeable between two serially connected membranes or between two serially connected flow channels or between two serially connected polymerization reactors. It is thus possible to remove a polymer stream for example or, possibly more advantageously, to introduce further initiator or for example a chain-transfer agent into the polymerization stream, in order thus to influence the molecular weight distribution of the product. The length of the connected reactors or membranes may be adapted such that the initiator addition or another addition is carried out at precisely the desired time.

The invention shall now be elucidated by way of example with reference to the attached drawings, wherein the features shown below may represent an aspect of the invention both individually or in combination and wherein the invention is not restricted to the following drawing, the following description and the following exemplary embodiment.

In the figures:

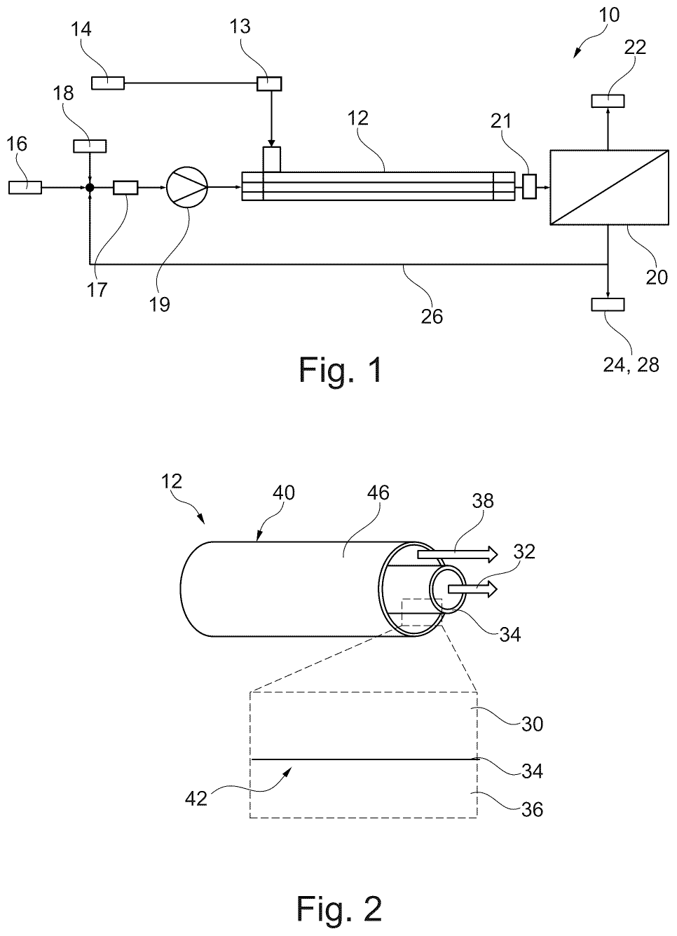

FIG. 1 shows an assembly comprising a polymerization reactor for performing the process according to the present invention;

FIG. 2 shows an enlarged view of an embodiment of the polymerization reactor for an assembly from FIG. 1:

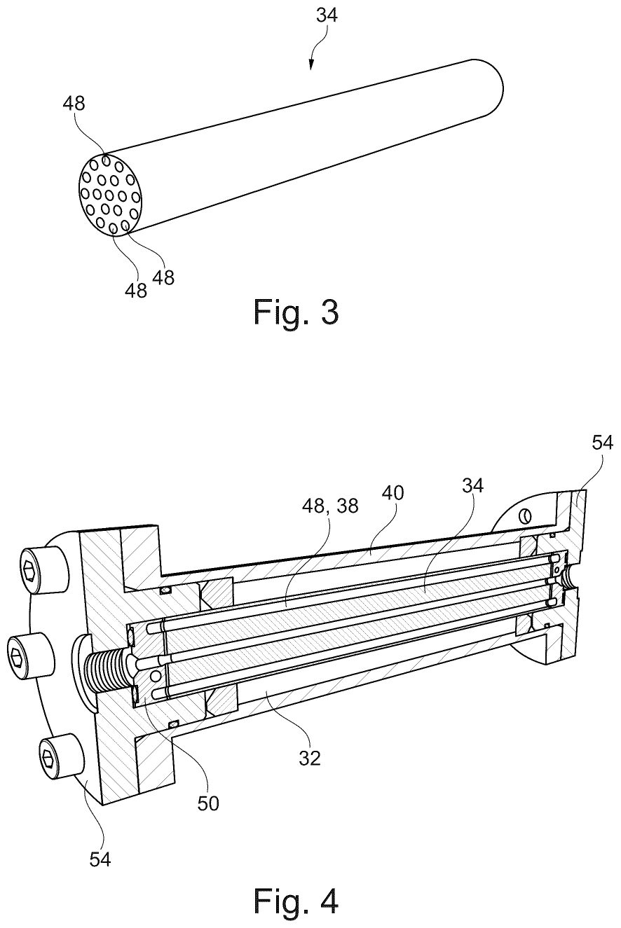

FIG. 3 shows a membrane for a polymerization reactor:

FIG. 4 shows a polymerization reactor comprising the membrane from FIG. 3:

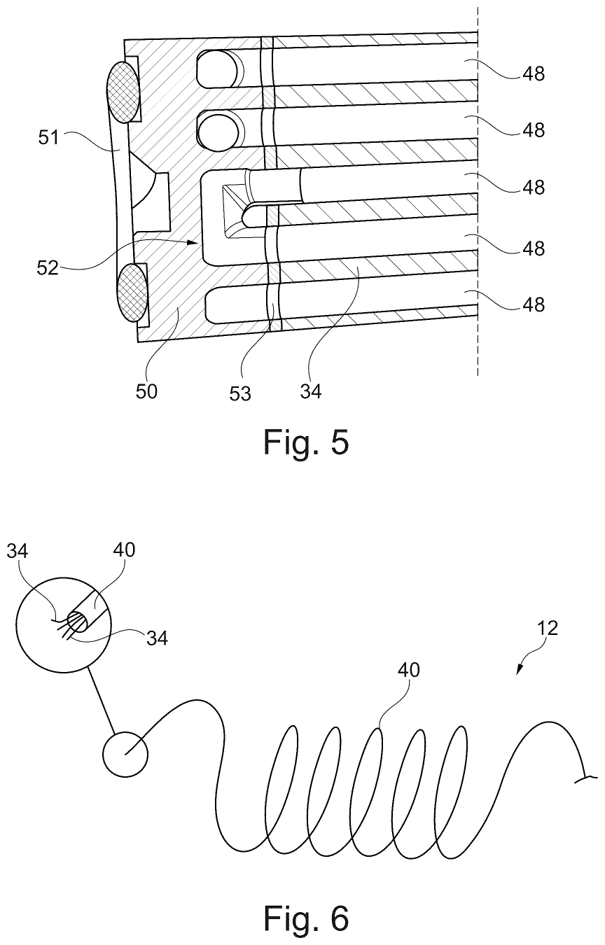

FIG. 5 shows a detail view of the polymerization reactor from FIG. 4, with in particular the cap structure being shown; and

FIG. 6 shows a further embodiment of the polymerization reactor for a process according to the present invention.

FIG. 1 shows an assembly 10 comprising a polymerization reactor 12 for performing the process according to the present invention. Such a process is used for production of polyvinylidene fluoride by polymerization of vinylidene fluoride. Addition of further monomers in addition to vinylidene fluoride also makes it possible to produce a polyvinylidene fluoride copolymer, wherein the following embodiments relating to the production of polyvinylidene fluoride are correspondingly applicable.

In the arrangement 10 according to FIG. 1, the gaseous monomer vinylidene fluoride is withdrawn from a reservoir 14 and passed into the polymerization reactor 12. A pressure controller 13, for example a pressure reducer or a compressor, which may be selected according to the pressure prevailing in the reservoir 14 is arranged downstream of the reservoir 14. Furthermore, an aqueous polymerization solution is passed into the polymerization reactor 12. For instance water, optionally comprising an initiator, may be withdrawn from a tank 16 and, from a tank 18, an emulsifier, likewise in the form of an aqueous solution for example, may be added and mixed with the water. One or both of the tanks 16, 18 may be preheated to bring about initial decomposition of the initiator and to ensure the presence of free radicals that promote polymerization already at the reactor inlet. However, the preheating may also be carried out in the conduit leading to the polymerization reactor 12. It is potentially also possible not to separate the two tanks 16, 18 and to utilize only one which contains initiator and emulsifier in water.

It is also shown that a degasifier 17, such as for instance a membrane degasifier, may be provided between the tanks 16, 18 and the polymerization reactor 12, for instance upstream of a pump 19, to keep the solution in the polymerization reactor 12 as free from oxygen as possible. This may be important since oxygen has an inhibiting effect on the reaction and should be removed from all process streams. Accordingly, the tanks 16, 18 may also be purged with an inert gas, for instance with nitrogen or argon, to keep the initial oxygen content upstream of the degasifier 17 as low as possible.

A polymerization such as is described in more detail below is carried out in the polymerization reactor 12. To summarize, the polymerization reactor 12 is provided with a membrane 34, which is for example porous and hydrophobic or hydrophilic, to ensure an optimized phase interface between the gaseous monomer and the aqueous phase, as shown below.

The outlet of the polymerization reactor 12 is connected to an optional filter unit 20 in which the polymer product 22 produced, i.e. solid PVDF particles, may optionally be separated from the aqueous phase. The water or the filtrate 24 may accordingly be recycled in a recyclate stream 26 and further purified in a circuit to be reused for the polymerization process. A purge stream 28 may be used to prevent enrichment of additives or impurities of the reaction in the process. The polymer product 22 may be purified and accordingly obtained in pure form. However, immediate further use of the product stream withdrawn from the polymerization reactor 12 is also possible.

An overflow valve 21, which may also be referred to as backpressure regulator, is shown downstream of the polymerization reactor 12 and for instance upstream of the filter unit 20.

Various embodiments of the polymerization reactor 12 are described below. The polymerization reactors 12 as shown below may be used for instance in an assembly 10 as described above but are not limited thereto.

The polymerization reactor 12 is shown in FIG. 2 in a general form. It is apparent that the polymerization reactor 12 comprises a monomer space 30 for receiving monomer gas as monomer stream 32 and a polymerization space 36, separated from the monomer space 30 by the hydrophobic or hydrophilic and optionally porous membrane 34, for receiving the aqueous polymerization solution as stream 38 of polymerization medium. The polymerization space 36 is outwardly delimited by a reactor housing 40 which like the membrane 34 may have a tubular structure. Monomer space 30 and polymerization space 36 may in principle also be interchanged. Monomer stream 32 and the stream 38 of polymerization medium are shown in cocurrent, but a countercurrent is also possible in principle.

The enlarged view of FIG. 2 shows in particular the monomer space 30 and the polymerization space 36 in which monomer stream 32 and the stream 38 of polymerization medium, separated by the membrane 34, are shown. The membrane 34 may be porous or else media-tight. Monomer gas may pass through the membrane 34 into the polymerization solution and thus, in particular by emulsion polymerization, form the polymer. To this end, the aqueous phase or the polymerization solution may be preheated before entry into the polymerization reactor 12 and the polymerization reactor 12 itself further temperature-controlled, for instance via a heating tape 46 over the reactor housing 40 or by immersion of the polymerization reactor 12 in a heating bath, for instance with temperature-control oil. The process pressure may be built up via a proportional overflow valve as described above.

The membrane 34 and the pressure difference between both phases allows the phase interface 42 to be stabilized and breakthrough of water or gas to the respective other side to be prevented. This results in bubble-free introduction of monomer into the aqueous reaction phase over the entire length of the polymerization reactor 12, thus ensuring that the aqueous phase is completely saturated with monomer everywhere and the maximum amount of monomer is available for the polymerization.

The continuously operable polymerization reactor 12 and its improved mass transfer properties make it possible to effect continuous production of PVDF at lower process pressures, without mechanical energy input and with shorter residence times. It is in particular possible to effect continuous production of PVDF at pressures below 20 bar and residence times of less than 1 h. Fluoroemulsifiers are preferably not employed. Employable emulsifiers include various meroxapols or poloxamers. These are harmless to humans and the environment and also used for example in cosmetics products, so are also employable without issue for the polymerization performed here.

FIG. 3 shows an embodiment of a membrane 34, wherein FIG. 4 shows the corresponding use of the membrane 34 from FIG. 3 in a polymerization reactor 12. The polymerization reactor 12 may in particular be suitable for inflexible or rigid membranes 34.

The membrane 34 comprises a plurality of in particular serially connectable or connected flow channels 48 which may also be referred to as lumens. Up to 19 or more flow channels 48 may be provided, for example. The membrane 34 has for example an average pore diameter of 50 nm, a length of 200 mm and in the present case 19 parallel flow channels 48. The stream 38 of polymerization medium may accordingly flow through these sequentially and the monomer stream 32 may then flow outside the membrane 34 but inside the reactor housing 40.

To achieve serial connection of the flow channels 48, it is possible to provide appropriate caps 50 having incorporated deflection structures 52 which deflect the stream 38 of polymerization medium between the flow channels 48. These are shown in more detail in FIG. 5. This results in an exemplary lumen-side total length of the membrane 34 of 3.8 m.

The polymerization reactor 12 of FIGS. 4 and 5 may further also be provided with an overflow valve 21 shown in FIG. 1.

The polymerization reactor 12 may be sealed in the axial direction using corresponding end pieces 54. FIGS. 4 and 5 further show a corresponding seal 51, here in the form of an O-ring, by means of which the cap 50 may be fluidtightly and gastightly connected to the end piece 54. Also shown is a seal 53, in particular in the form of a sealing disc, by means of which the membrane 34 may be fluidtightly and gastightly connected to the cap 50.

FIG. 6 shows a further embodiment of a polymerization reactor 12. In the embodiment according to FIG. 6, the polymerization reactor 12 comprises a plurality of tubular membranes 34, in particular connected in parallel, which are arranged in a common reactor housing 40. This embodiment may be advantageous in particular for flexible membranes 34.

It is also shown that the polymerization reactor 12 has a cylindrically wound configuration. This embodiment allows for very space-saving or compact operation despite a relatively long reaction duration.

More particularly, for instance membranes 34 made of polypropylene having an average pore 5 diameter of 100 nm and a length of 3 m are used. A plurality of these membranes 34 are installed into a cylindrically wound stainless steel tube as reactor housing 40 having a total length of 2.5 m and sealed at the ends of the reactor for instance with epoxy resin such that the gas phase is introduced into the lumen channel or flow channel 48 of the membrane 34 and the aqueous phase flows around the membranes 34 on the shell side. To provide the minimum necessary temperature for the reaction of about 75° C., the polymerization reactor 12 may be temperature-controlled 10 accordingly. To establish the necessary process pressure in the aqueous phase, for instance a proportional overflow valve 21 is used downstream of the reactor outlet, as shown in FIG. 1. Temperature-control of the polymerization solution to a range from 50° C. to 100° C. may in principle be advantageous.

### REFERENCE NUMERALS

10 Assembly
12 Polymerization reactor
13 Pressure controller
14 Reservoir
16 Tank
17 Degasifier
18 Tank
19 Pump
20 Filter unit
21 Overflow valve
22 Polymer product
24 Filtrate
26 Recyclate stream
28 Purge stream
30 Monomer space
32 Monomer stream
34 Membrane
36 Polymerization space
38 Stream of polymerization medium
40 Reactor housing
42 Phase interface
46 Heating tape
48 Flow channel
50 Cap
51 Seal
52 Deflection structure
53 Seal
54 End piece

1. Process for producing polyvinylidene fluoride or a polyvinylidene fluoride copolymer by polymerization of at least vinylidene fluoride as monomer, wherein the process comprises at least the process steps of:
i) providing a continuously operable polymerization reactor, wherein the polymerization reactor comprises a monomer space and a polymerization space separated from the monomer space by a membrane;
ii) introducing vinylidene fluoride into the monomer space at a first pressure p₁;
iii) introducing an aqueous polymerization solution into the polymerization space at a second pressure p₂, wherein
iv) p₁ is greater than or equal to or less than p₂; wherein
v) the vinylidene fluoride passes into the aqueous polymerization solution and
vi) a polymerization of vinylidene fluoride to afford polyvinylidene fluoride or a polyvinylidene fluoride copolymer occurs in the polymerization space.

2. Process according to claim 1, characterized in that the membrane comprises at least one of a ceramic and a polymer.

3. Process according to claim 2, characterized in that the membrane is made of a material selected from the group consisting of aluminium oxide, titanium dioxide, zirconium dioxide, polytetrafluoroethylene, polydimethylsiloxane and polypropylene.

4. Process according to claim 1, characterized in that process steps ii) and iii) are carried out in such a way that gas bubble-free introduction of monomer gas into the aqueous polymerization solution is effected.

5. Process according to claim 1, characterized in that a pressure difference between p₁ and p₂ is in a range of ≤2 bar.

6. Process according to claim 1, characterized in that the pressure in the polymerization reactor is in a range of ≤50 bar.

7. Process according to claim 1, characterized in that the polymerization reactor comprises a plurality of in particular serially connected tubular membranes arranged in a common reactor housing.

8. Process according to claim 1, characterized in that the membrane comprises a plurality of in particular serially connected flow channels.

9. Process according to claim 1, characterized in that the polymerization reactor has a cylindrically wound configuration, in particular wherein at least two membranes connected in parallel are present in the polymerization reactor.

10. Process according to claim 1, characterized in that the polymerization space has a static mixer structure arranged in it.

11. Process according to claim 1, characterized in that at least one of the membrane and the mixer structure has been provided with a catalyst.

12. Process according to claim 1, characterized in that the process is carried out in the absence of emulsifiers.

13. Process according to claim 1, characterized in that the process is carried out using emulsifiers selected from the group consisting of meroxapols and poloxamers.

14. Process according to claim 1, characterized in that the polymerization solution is heated to a temperature in a range from ≥50° C. to ≤100° C.

15. Process according to claim 1, characterized in that the process is performed in at least two serially connected polymerization reactors.

16. Process according to claim 1, characterized in that, in a polymerization reactor, a material stream is introducible or dischargeable between two serially connected membranes or between two serially connected flow channels or between two serially connected polymerization reactors.

17. Process according to claim 1, characterized in that the membrane separating the monomer space and the polymerization space exhibits hydrophobic properties.

18. Process according to claim 1, characterized in that the membrane separating the monomer space and the polymerization space exhibits hydrophilic properties.
